(19) United States
(12) Patent Application Publication
(10) Pub. No.: US 2013/0021541 A1
(43) Pub. Date: Jan. 24, 2013

(54) ELECTRO-OPTIC DEVICE AND PROJECTION TYPE DISPLAY APPARATUS

(71) Applicant: Satoshi Ito, Eniwa-shi (JP)

(72) Inventor: Satoshi Ito, Eniwa-shi (JP)

(73) Assignee: Seiko Epson Corporation, Tokyo (JP)

(21) Appl. No.: 13/548,267

(22) Filed: Jul. 13, 2012

(30) Foreign Application Priority Data
Jul. 22, 2011 (JP) 2011-160717

(51) Int. Cl. G02F 1/1343; G02F 1/1335

(52) U.S. Cl. 349/5; 349/139

(57) ABSTRACT

An electro-optic device includes a substrate body (transparent substrate) of a second substrate. The substrate body is provided with a first groove opened to a space (inter-pixel area) between pixel electrodes adjacent to each other. A transparent film is formed on one side face of the substrate body and side faces of the first groove, a second groove deeper than the first groove narrower than the first groove is formed at an area overlapped with the first groove in plan view in the transparent film. For this reason, light which tends to be directed to the inter-pixel area is directed to the pixel electrodes using the side faces of the second groove as reflection faces.

### BACKGROUND

1. Technical Field

The present invention relates to an electro-optic device such as a liquid crystal device, and a projection type display apparatus provided with the electro-optic device.

2. Related Art

Among various electro-optic devices, as shown in FIG. 9, a liquid crystal device includes a first substrate 1010 that is provided with a plurality of pixel electrodes 1009a and switching elements (not shown), a second substrate 1020 that is opposed to the first substrate 1010, and a liquid crystal layer 1050 as an electro-optic material layer provided between the first substrate 1010 and the second substrate 1020. Among such liquid crystal devices, in the liquid crystal device of a TN (Twisted Nematic) mode or a VA (Vertical Alignment) mode, a common electrode 1021 is formed on the second substrate 1020. In the liquid crystal device, alignment of the liquid crystal layer 1050 is controlled between the common electrode 1021 and the pixel electrodes 1009a, and thus light input from the second substrate 1020 side is modulated and output as display light from the first substrate 1010.

Concerning the liquid crystal device, a technique is proposed in which etching is performed on one side face of a dust-proof glass constituting a part of the second substrate 1020 to form a cross-sectional V shaped groove 1260 opened toward an area (inter-pixel area 1010f) between the pixel electrodes 1009a, then a transparent cover glass 1024 is adhered by an adhesive 1023, and side faces 1261 and 1262 of the hollow groove 1260 filled with the air are used as reflection faces. According to the technique, the light directed to the pixel electrodes 1009a of the light input from the second substrate 1020 side propagates as represented by arrows L11. As represented by an arrow L12, the light directed in a direction (a direction to the inter-pixel area 1010f) deviating from the pixel electrodes 1009a is reflected by the side faces 1261 and 1262 of the groove 1260 directed to the pixel electrodes 1009a as represented by an arrow L13. For this reason, it is possible to efficiently lead the light input from the second substrate 1020 side to the pixel electrodes 1009a.

To raise efficiency of using the light by the technique described in JP-A-2006-215427, it is necessary to significantly deeply form the groove 1260 with a narrow width, but the depth limit is about 25 μm when the groove 1260 is formed by the etching. When the groove 1260 is formed by the etching, a face-shaped bottom portion 1264 is formed in the groove 1260, and the light input to the bottom portion 1264 is not directed to the pixel electrodes 1009a and thus does not contribute to displaying.

### SUMMARY

An advantage of some aspects of the invention is to provide an electro-optic device in which a structure of a groove constituting a reflection portion is improved such that incident light is more efficiently directed to pixel electrodes, and a projection type display apparatus provided with the electro-optic device.

According to an aspect of the invention, there is provided an electro-optic device including: a first substrate that is provided with a plurality of pixel electrodes and switching elements corresponding to the pixel electrodes; a second substrate that is opposed to the first substrate; and an electro-optic material layer that is provided between the first substrate and the second substrate, wherein one of the first substrate and the second substrate is a transparent substrate, and includes a first groove opened to a space between adjacent pixel electrodes in the plurality of pixel electrode, a transparent film that is laminated on the substrate surface such that a film thickness of the transparent film overlapped with the substrate face to which the first groove is opened and with the substrate face and at side faces of the first groove is thicker than the transparent film thickness of a part overlapped with the side faces of the first groove, and has a second groove being deeper than the first groove in an area overlapped with the first groove in plan view and having a width narrower than that of the first groove, and a sealing layer that blocks the second groove such that a refractive index in the second groove is smaller than a refractive index of the transparent film.

In the electro-optic device according to the aspect of the invention, one side substrate of the first substrate and the second substrate is a transparent substrate, and the transparent substrate is provided with the first groove opened to the space between the pixel electrodes adjacent to each other. The transparent film is formed on the substrate face of the transparent substrate to which the first groove is opened, the second groove deeper than the first groove and narrower than the first groove is formed in the area overlapped with the first groove in the plan view by the transparent film. The refractive index in the second groove is smaller than the refractive index of the transparent film. For this reason, since it is possible to use the side faces of the second groove as the reflection faces, it is possible to direct the light, which tends to be directed to the space between the pixel electrodes, to the pixel electrodes. The second groove is deeper than the first groove formed by etching or the like, and the reflection faces (side faces) thereof are larger than those. Since the bottom portion of the second groove is narrower than the bottom portion of the first groove, the loss of the light caused by the inputting of the light to the bottom portion of the groove is small. Accordingly, it is possible to efficiently direct the light, which tends to be directed to the space between the pixel electrodes, to the pixel electrodes, it is possible to raise the light quantity contributing to the displaying, and thus it is possible to display a bright image.

In the electro-optic device according to the aspect of the invention, the side faces of the first groove and the side faces of the second groove may be inclination faces inclined toward the space between the adjacent pixel electrodes. With such a configuration, the light which tends to be directed to the space between the pixel electrodes is reflected by the reflection faces, and thus it is possible to efficiently direct the light to the pixel electrodes.

In the electro-optic device according to the aspect of the invention, a film thickness of a part of the transparent film overlapped with the side faces of the first groove may be tapered from the opening portion side of the first groove toward a bottom portion of the first groove. With such a configuration, it is possible to make an angle formed by the side face of the second groove and a normal direction to the substrate face smaller than an angle formed by the side face of the first groove and a normal direction to the substrate face.

In the electro-optic device according to the aspect of the invention, the side faces of the second groove may have a cross-sectional V shape in which the side faces are connected at a bottom portion thereof. With such a configuration, the second groove is deeper than the formed first groove, and the reflection faces (side faces) thereof are larger than those. At the bottom portion of the second groove, it is possible to suppress the amount of the light input to the bottom portion of the second groove to be minimal as possible.

In the electro-optic device according to the aspect of the invention, the transparent film may be silicate glass. That is, the transparent film may be glass (silicon oxide film) using tetraethoxysilane (Si(OC₂H₅)₄) as a raw gas. With such a configuration, a coverage property at the time of forming the film is high, and thus it is suitable to form the second groove deeper than the first groove and narrower than the first groove when forming the film on the substrate face of the transparent film and the side faces of the first groove.

In the electro-optic device according to the aspect of the invention, the second groove may be hollow therein. With such a configuration, it is possible to use the side faces of the hollow second groove as the reflection faces with high reflectance.

In the electro-optic device according to the aspect of the invention, the second groove is in a vacuum state therein. With such a configuration, it is possible to easily realize the electro-optic device only by forming the sealing layer by forming the film in a vacuum atmosphere.

In the electro-optic device according to the aspect of the invention, the first groove and the second groove may be provided in the second substrate. With such a configuration, it is possible to employ a configuration in which light is input from the second substrate side, and thus there is an advantage that the light it not easily input to the switching element.

In this case, the pixel electrodes and the first substrate may have transparency. With such a configuration, it is possible to configure a transmission-type electro-optic device.

The electro-optic device according to the aspect of the invention may be used in a projection type display apparatus. In this case, the projection type display apparatus includes a light source unit that outputs the light input from one substrate to the electro-optic device, and a projective optical system that projects the light modulated by the electro-optic device. In the case of the projection type display apparatus, particularly, it is preferable that efficiency of using incident light is high, and thus an effect is significant when the invention is applied to the electro-optic device.

### BRIEF DESCRIPTION OF THE DRAWINGS

The invention will be described with reference to the accompanying drawings, wherein like numbers reference like elements.

FIG. 1 is a schematic diagram illustrating a configuration of a projection type display apparatus to which the invention is applied.

FIG. 2A and FIG. 2B are diagrams illustrating a basic configuration of a liquid crystal panel used in a liquid crystal light valve (electro-optic device/liquid crystal device) in the projection type display apparatus shown in FIG. 1.

FIG. 3A and FIG. 3B are diagrams illustrating an example of a specific configuration of the liquid crystal panel used in the electro-optic device according to Embodiment 1 of the invention.

FIG. 4A and FIG. 4B are diagrams illustrating a pixel of the electro-optic device of Embodiment 1 of the invention.

FIG. 5A and FIG. 5B are diagrams illustrating a reflection portion formed on a second substrate of the electro-optic device according to Embodiment 1 of the invention.

FIG. 6A to FIG. 6D are diagrams illustrating a method of producing the electro-optic device according to Embodiment 1 of the invention.

FIG. 7 is a diagram illustrating a reflection portion formed on a second substrate of an electro-optic device according to Embodiment 2 of the invention.

FIG. 8 is a diagram illustrating a reflection portion formed on a second substrate of an electro-optic device according to Embodiment 3 of the invention.

FIG. 9 is a diagram illustrating a reflection portion formed on a second substrate of an electro-optic device of the related art.

### DESCRIPTION OF EXEMPLARY EMBODIMENTS

A projection type display device using an electro-optic device (liquid crystal device) to which the invention is applied, the electro-optic device, and a method of producing the electro-optic device will be described with reference to the drawings. In the drawings referred by the following description, the scale of each layer and each member is made different so as to be such a size as to aide recognition of each layer and each member on the drawings.

### Embodiment 1

### Configuration of Projection Type Display Apparatus

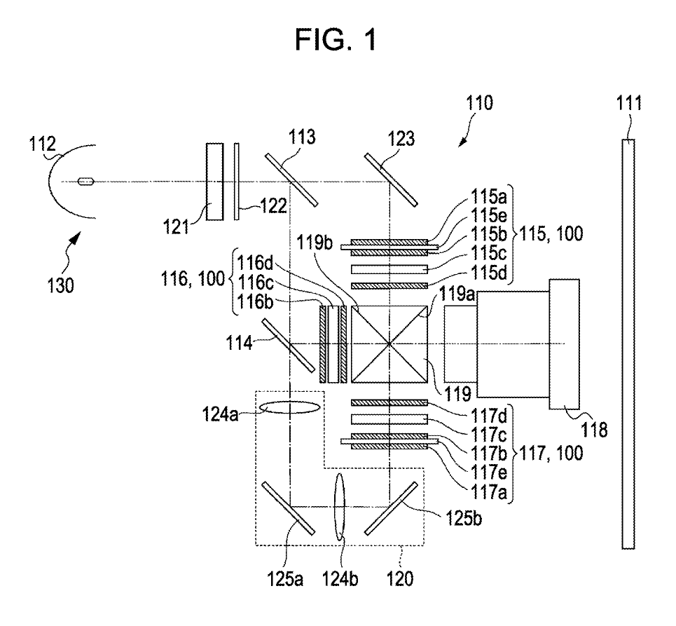

A projection type display apparatus using an electro-optic device according to Embodiment 1 of the invention as a light valve will be described with reference to FIG. 1. FIG. 1 is a schematic diagram illustrating a configuration of the projection type display apparatus according to the invention.

In FIG. 1, the projection type display apparatus 110 is a so-called projection type display apparatus which irradiates a screen 111 provided on an observer side with light to observe light reflected by the screen 111. The projection type display apparatus 110 includes a light source unit 130 provided with a light source 112, dichroic mirrors 113 and 114, liquid crystal light valves 115 to 117 (electro-optic devices 100 and liquid crystal devices), a projective optical system 118, a cross-dichroic prism 119, and a relay system 120.

The light source 112 is formed of an ultrahigh pressure mercury lamp supplying light including red light, green light, and blue light. The dichroic mirror 113 allows red light from the light source 112 to pass, and reflects the green light and the blue light. The dichroic mirror 114 allows the blue light of the green light and the blue light reflected by the dichroic mirror 113 to pass, and reflects the green light. As described above, the dichroic mirrors 113 and 114 constitute a color division optical system dividing the light output from the light source 112 into the red light, the green light, and the blue light.

An integrator 121 and a polarization conversion element 122 are disposed between the dichroic mirror 113 and the light source 112 in order from the light source 112. The integrator 121 equalizes illumination intensity of the light output from the light source 112. The polarization conversion element 122 makes the light output from the light source 112 into polarized light having a specific vibration direction such as s-polarized light.

The liquid crystal light valve 115 is a transmission type electro-optic device 100 that modulates the red light passing through the dichroic mirror 113 and reflected by a reflection mirror 123 according to an image signal. The liquid crystal light valve 115 includes a λ/2 phase difference plate 115a, a first polarization plate 115b, a liquid crystal panel 115c, and a second polarization plate 115d. When the red light input to the liquid crystal light valve 115 passes through the dichroic mirror 113, the polarization of the light is not changed, and thus the red light is the s-polarized light.

The λ/2 phase difference plate 115a is an optical element that converts the s-polarized light input to the liquid crystal light valve 115 into p-polarized light. The first polarization plate 115b is a polarization plate that blocks the s-polarized light and allows the p-polarized light to pass. The liquid crystal panel 115c converts the p-polarized light into the s-polarized light (in a case of halftone, circular polarized light or elliptical polarized light) by the modulation according to the image signal. The second polarization plate 115d is a polarization plate that blocks the p-polarized light and allows the s-polarized light to pass. Accordingly, the liquid crystal light valve 115 modulates the red light according to the image signal, and outputs the modulated red light to the cross-dichroic prism 119.

The λ/2 phase difference plate 115a and the first polarization plate 115b are disposed to come in contact with the transparent glass plate 115e which does not convert the polarized light, and it is possible to avoid the λ/2 phase difference plate 115a and the first polarization plate 115b being warped by heat generation.

The liquid crystal light valve 116 is a transmission type electro-optic device 100 that modulates the green light reflected by the dichroic mirror 113 and then reflected by the dichroic mirror 114 according to the image signal. The liquid crystal light valve 116 includes a first polarization plate 116b, a liquid crystal panel 116c, and a second polarization plate 116d, similarly to the liquid crystal light valve 115. The green light input to the liquid crystal light value 116 is s-polarized light which is reflected and input by the dichroic mirrors 113 and 114. The first polarization plate 116b is a polarization plate that blocks the p-polarized light and allows the s-polarized light to pass. The liquid crystal panel 116c converts the s-polarized light into the p-polarized light (in a case of halftone, circular polarized light or elliptical polarized light) by the modulation according to the image signal. The second polarization plate 116d is a polarization plate that blocks the s-polarized light and allows the p-polarized light to pass. Accordingly, the liquid crystal light valve 116 modulates the green light according to the image signal, and outputs the modulated green light to the cross-dichroic prism 119.

The liquid crystal light valve 117 is a transmission type electro-optic device 100 modulates the blue light reflected by the dichroic mirror 113, passing through the dichroic mirror 114, and then passing through the relay system 120, according to the image signal. The liquid crystal light valve 117 includes a λ/2 phase difference plate 117a, a first polarization plate 117b, a liquid crystal panel 117c, and a second polarization plate 117d, similarly to the liquid crystal light valves 115 and 116. The blue light input to the liquid crystal light valve 117 is reflected by the dichroic mirror 113, passing through the dichroic mirror 114, and then reflected by two reflection mirrors 125a and 125b to be described later of the relay system 120, thereby being s-polarized light.

The λ/2 phase difference plate 117a is an optical element that converts the s-polarized light input to the liquid crystal light valve 117 into p-polarized light. The first polarization plate 117b is a polarization plate that blocks the s-polarized light and allows the p-polarized light to pass. The liquid crystal panel 117c converts the p-polarized light into the s-polarized light (in a case of halftone, circular polarized light or elliptical polarized light) by the modulation according to the image signal. The second polarization plate 117d is a polarization plate that blocks the p-polarized light and allows the s-polarized light to pass. Accordingly, the liquid crystal light valve 117 modulates the blue light according to the image signal, and outputs the modulated blue light to the cross-dichroic prism 119. The λ/2 phase difference plate 117a and the first polarization plate 117b are disposed to come in contact with the glass plate 117e.

The relay system 120 includes relay lenses 124a and 124b and reflection mirrors 125a and 125b. The relay lenses 124a and 124b are provided to prevent light loss caused by a long length of an optical path of the blue light. The relay lens 124a is disposed between the dichroic mirror 114 and the reflection mirror 125a. The relay lens 124b is disposed between the reflection mirrors 125a and 125b. The reflection mirror 125a is disposed to reflect the blue light passing through the dichroic mirror 114 and output from the relay lens 124a, to the relay lens 124b. The reflection mirror 125b is disposed to reflect the blue light reflected from the relay lens 124b to the liquid crystal light valve 117.

The cross-dichroic prism 119 is a color synthesis optical system in which two dichroic films 119a and 119b are orthogonally disposed in an X shape. The dichroic film 119a is a film that reflects the blue light and allows the green light to pass, and the dichroic film 119b is a film that reflects the red light and allows the green light to pass. Accordingly, the cross-dichroic prism 119 synthesizes the red light, green light, and blue light modulated by the liquid crystal light valves 115 to 117, respectively, and outputs the synthesized light to the projective optical system 118.

The light input from the liquid crystal light values 115 and 117 to the cross-dichroic prism 119 is s-polarized light, and the light input from the liquid crystal light valve 116 to the cross-dichroic prism 119 is p-polarized light. By inputting different kinds of polarized light to the cross-dichroic prism 119, it is possible to synthesize the light input from the liquid crystal light values 115 to 117 to the cross-dichroic prism 119. Generally, the dichroic films 119a and 119b are excellent in reflection transistor characteristics of s-polarized light. For this reason, the red light and blue light reflected by the dichroic films 119a and 119b are the s-polarized light, and the green light passing through the dichroic films 119a and 119b is the p-polarized light. The projective optical system 118 has a projection lens (not shown), and projects the light synthesized by the cross-dichroic prism 119 to the screen 111.

In the projection type display apparatus 110 configured as described above, efficiency of using the light output from the light source 112 is required to be high, and thus the electro-optic devices 100 as the liquid crystal light valves 115 to 117 employs a configuration to be described hereinafter.

### Overall Configuration of Electro-Optic Device 100

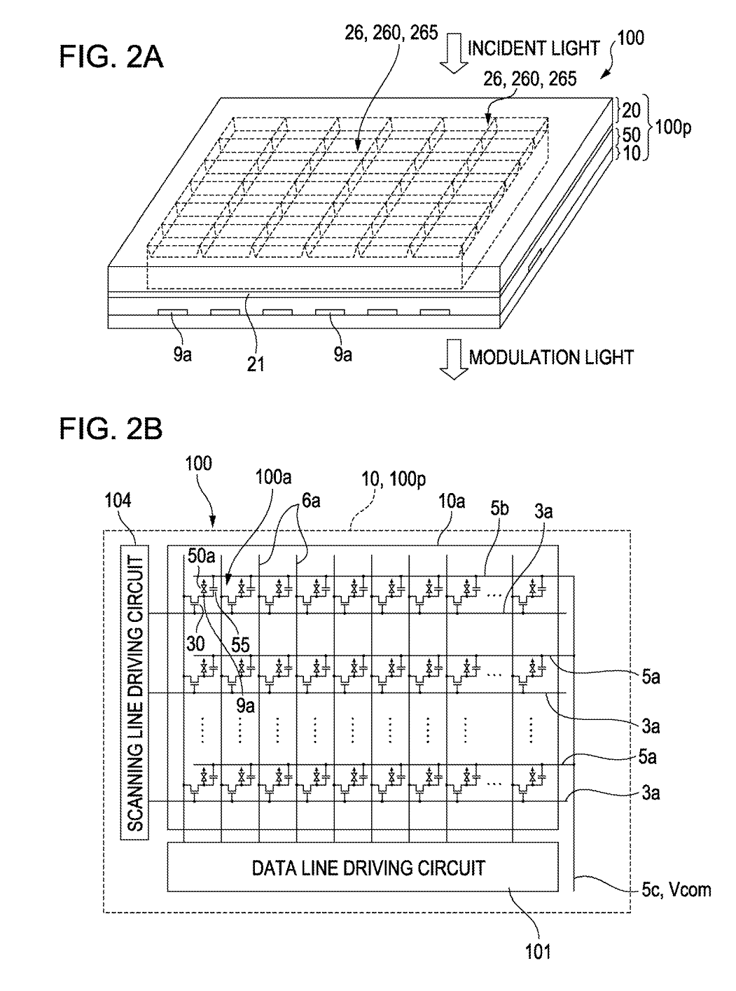

FIG. 2A and FIG. 2B are diagrams illustrating a basic configuration of a liquid crystal panel used in the liquid crystal light valves (electro-optic devices 100/liquid crystal devices) in the projection type display apparatus shown in FIG. 1, and FIG. 2A and FIG. 2B are a schematic diagram illustrating a basic structure of the liquid crystal panel and a block diagram illustrating an electrical configuration of the electro-optic device 100. The liquid crystal light valves 115 to 117 and the liquid crystal panels 115c to 117c shown in FIG. 1 are different from each other in wavelength areas of modulated light, and have a common basic configuration. Accordingly, the liquid crystal light valves 115 to 117 will be described as the electro-optic devices 100, and the liquid crystal panels 115c to 117c will be described as the liquid crystal panels 100p.

As shown in FIG. 2A, the electro-optic device 100 has the liquid crystal panel 100p of a TN (Twisted Nematic) mode and a VA (Vertical Alignment) mode. The liquid crystal panel 100p includes a first substrate 10, and a second substrate 20 opposed to the first substrate 10, and is a transmission type liquid crystal panel modulating the light input from the second substrate 20 side and outputting the light from the first substrate 10 side. The first substrate 10 and the second substrate 20 are combined and opposed through a seal member (not shown), and a liquid crystal layer 50 is kept in an inner area of the seal member. Although will be described later in detail, island-shaped pixel electrodes 9a or the like are formed on the face side of the first substrate 10 opposed to the second substrate 20, and a common electrode 21 is formed substantially on the whole face thereof on the face side of the second substrate 20 opposed to the first substrate 10. The second substrate 20 is provided with a reflection portion 26 using a first groove 260 and a second groove 265 to be described later.

As shown in FIG. 2B, in the electro-optic device 100 of the embodiment, the liquid crystal panel 100p is provided with an image display area 10a (pixel area) in which a plurality of pixels 100a are arranged in matrix at the center area thereof. In the liquid crystal panel 100p in the first substrate 10 (see FIG. 2A, FIG. 2B, and the like), a plurality of data lines 6a and a plurality of scanning lines 3a are vertically and horizontally arranged in the image display area 10a, and the pixels 100a are provided at positions corresponding to intersection points thereof. Each of the plurality of pixels 100a is provided with a pixel transistor 30 (switching element) formed of a field-effect transistor and the pixel electrode 9a (see FIG. 2A, FIG. 2B, and the like). A source of the pixel transistor 30 is electrically connected to the data line 6a, a gate of the pixel transistor 30 is electrically connected to the scanning line 3a, and a drain of the pixel transistor 30 is electrically connected to the pixel electrode 9a.

The first substrate 10 is provided with a scanning line driving circuit 104 and a data line driving circuit 101 on the outer peripheral side from the image display area 10a. The data line driving circuit 101 is electrically connected to the data lines 6a, and sequentially supplies image signals supplied from an image processing circuit, to the data lines 6a. The scanning line driving circuit 104 is electrically connected to the scanning lines 3a, and sequentially supplies scanning signals to the scanning lines 3a.

In each pixel 100a, the pixel electrode 9a is opposed with the common electrode 21 (see FIG. 2A, FIG. 2B, and the like) formed on the second substrate 20 and the liquid crystal layer 50, and constitutes a liquid crystal capacitance 50a. To each pixel 100a, an accumulation capacitance 55 is added in parallel to the liquid crystal capacitance 50a to prevent the image signal kept in the liquid crystal capacitance 50a from fluctuating. In the embodiment, to constitute the accumulation capacitance 55, a first electrode layer 5a is formed as a capacitance electrode layer over the plurality of pixels 100a. In the embodiment, the first electrode layer 5a is electrically connected to a common potential line 5c to which common potential Vcom is applied.

### Example of Specific Configuration of Electro-Optic Device 100

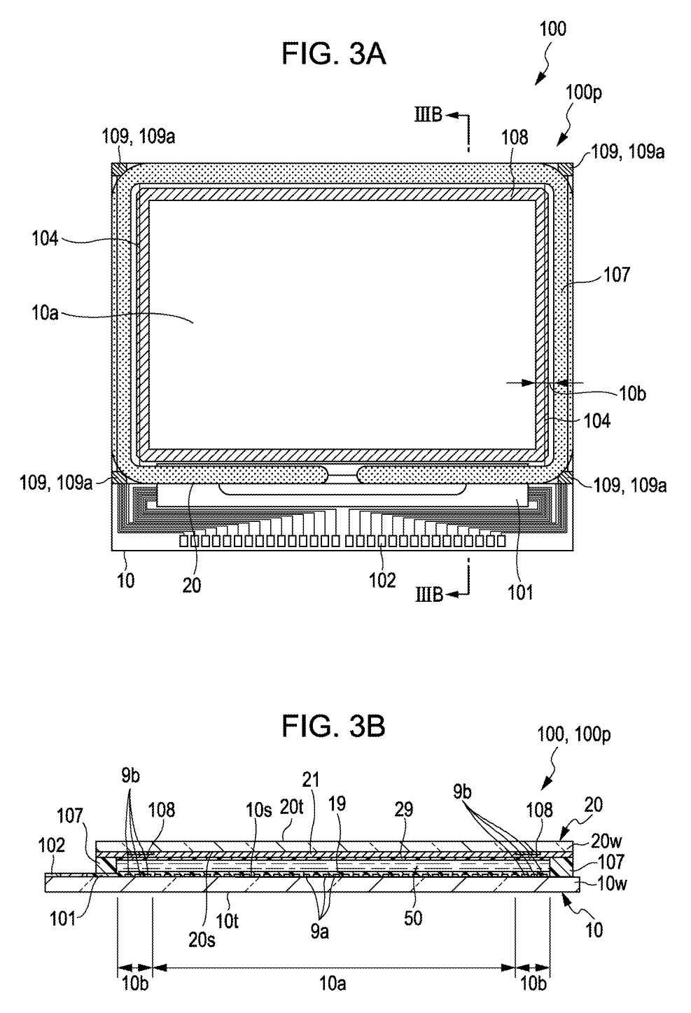

FIG. 3A and FIG. 3B are diagrams illustrating an example of a specific configuration of the liquid crystal panel 100p used in the electro-optic device 100 according to Embodiment 1 of the invention, and FIG. 3A and FIG. 3B are a plan view of the liquid crystal panel 100p viewed from the second substrate side together with constituent elements, and a cross-sectional view taken along the line IIIB-IIIB. In FIG. 3B, the reflection portion 26 to be described later is not shown.

As shown FIG. 3A and FIG. 3B, in the liquid crystal panel 100p, the first substrate 10 and the second substrate 20 are combined by a seal member 107 through a predetermined gap, and the seal member 107 is provided in a frame shape along an outer frame of the second substrate 20. The seal member 107 is an adhesive agent formed of light-curable resin, heat-curable resin, or the like, and a gap member such as a glass fiber or a glass bead for making a distance between both substrates to be a predetermined value is combined.

In the liquid crystal panel 100p with such a configuration, both of the first substrate 10 and the second substrate 20 are rectangular, the image display area 10a described with reference to FIG. 2A and FIG. 2B is provided as a rectangular area substantially at the center of the liquid crystal panel 100p. The seal member 107 is also provided substantially in the rectangular shape corresponding to the shape described above, and a substantially rectangular peripheral area 10b is provided in a frame shape between an inner peripheral edge of the seal member 107 and an outer peripheral edge of the image display area 10a. In the first substrate 10, the data line driving circuit 101 and a plurality of terminals 102 are formed along one side of the first substrate 10 on the outside of the image display area 10a, and the scanning line driving circuit 104 is formed along the other side adjacent to the one side. The terminal 102 is connected to a flexible wiring board (not shown), and various kinds of potential and various signals are input to the first substrate 10 through the flexible wiring board.

Although will be described later in detail, the pixel transistors 30 described with reference to FIG. 2B and the pixel electrodes 9a electrically connected to the pixel transistors 30 are formed in matrix in the image display area 10a on one face 10s side between one face 10s and the other face 10t of the first substrate 10, and an alignment film 19 is formed on an upper layer side of the pixel electrodes 9a.

Dummy pixel electrodes 9b (see FIG. 3B) formed together with the pixel electrode 9a are formed in the peripheral area 10b on one side 10s of the first substrate 10. In the dummy pixel electrodes 9b, a configuration of electrically connecting to dummy pixel transistors, a configuration of directly and electrically connecting to connection lines without providing the dummy pixel transistors, or a configuration of a floating state in which potential is not applied are employed. When the face on which the alignment film 19 is formed on the first substrate 10 is planarized by polishing, the dummy pixel electrode 9b compresses the height position of the image display area 10a and the peripheral area 10b and contributes to make the face on which the alignment film 19 is formed to be a flat face. When the dummy pixel electrode 9b is set to predetermined potential, it is possible to prevent disarray of alignment of liquid crystal molecules at the end portion of the outer peripheral side of the image display area 10a.

The common electrode 21 is formed on one face 20s opposed to the first substrate 10 between one face 20s and the other face 20t of the second substrate 20, and the alignment film 29 is formed on the upper layer of the common electrode 21. The common electrode 21 is formed over the plurality of pixels 100a substantially on the whole face of the second substrate 20 or as a plurality of stripe-shaped electrodes. In the embodiment, the common electrode 21 is formed substantially on the whole face of the second substrate 20. A frame-shaped light shield layer 108 is formed along the outer periphery of the image display area 10a on one face 20s of the second substrate 20, and the light shield layer 108 serves as a boundary. The outer periphery of the light shield layer 108 is positioned across a gap from the inner peripheral edge of the seal member 107, and the light shield layer 108 and the seal member 107 are not overlapped with each other.

In the liquid crystal panel 100p with such a configuration, an inter-substrate connection electrode 109 for electrical connection between the first substrate 10 and the second substrate 20 is formed in an area overlapped with angular parts of the second substrate 20 on the outside from the seal member 107 on the first substrate 10. The inter-substrate connection electrode 109 is provided with an electrical connection member 109a including conductive particles, and the common electrode 21 of the second substrate 20 is electrically connected to the first substrate 10 side through the inter-substrate connection member 109a and the inter-substrate connection electrode 109. For this reason, the common potential Vcom is applied from the first substrate 10 side to the common electrode 21. The seal member 107 has substantially the same width dimension, and is provided along the outer periphery of the second substrate 20. For this reason, the seal member 107 is substantially rectangular. The seal member 107 is provided avoiding the inter-substrate connection electrode 109 and passing through the inside in an area overlapped with the angular parts of the second substrate 20, and the angular parts of the seal member 107 are substantially arc shaped.

In the electro-optic device 100 with such a configuration, when the pixel electrodes 9a and the common electrode 21 are formed by a transparent conductive film such as ITO (Indium Tin Oxide) or IZO (Indium Zinc Oxide), it is possible to configure a transmission type liquid crystal device. When the common electrode 21 is formed by a transparent conductive film such as ITO and IZO and the pixel electrodes 9a are formed by a reflective conductive film such as aluminum, it is possible to configure a reflection type liquid crystal device. When the electro-optic device 100 is the reflection type, the light input from the second substrate 20 side is modulated while the light is reflected by the substrate of the first substrate 10 side and is output, thereby displaying an image. When the electro-optic device 100 is the transmission type, the light input from one side substrate between the first substrate 10 and the second substrate 20 is modulated while the light passes through the other side substrate and is output, thereby displaying an image.

The electro-optic device 100 may be used as a color display device of an electronic apparatus such as a mobile computer and a mobile phone. In this case, a color filter (not shown) and a protective film are formed on the second substrate 20. In the electro-optic device 100, a phase difference film, a polarization plate, or the like is disposed in a predetermined direction with respect to the liquid crystal panel 100p according to the kind of used liquid crystal layer 50 or a normally white mode and a normally black mode.

In the embodiment, the electro-optic devices 100 are used as light valves for RGB in the projection type display apparatus (liquid crystal projector) described with reference to FIG. 1. In this case, light of colors divided through dichroic mirrors for RGB color division is input as projection light to each of the electro-optic devices 100 for RGB, and thus a color filter is not formed.

Hereinafter, the case where the electro-optic device 100 is the transmission type liquid crystal device and the light input from the second substrate 20 passes through the first substrate 10 and is output will be described. In the embodiment, a case where the electro-optic device 100 is provided with the liquid crystal panel 100p of a VA mode using a nematic liquid crystal compound, dielectric anisotropy of which is negative, as the liquid crystal layer 50 will be mainly described.

### Specific Configuration of Pixel

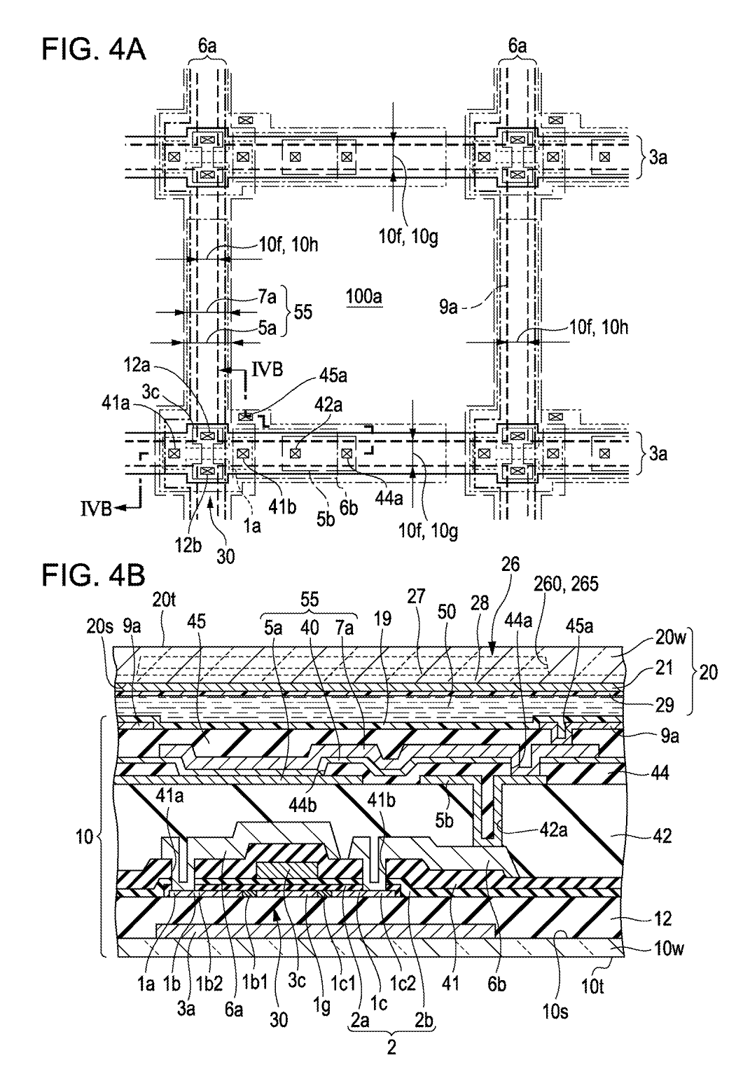

FIG. 4A and FIG. 4B are diagrams illustrating the pixels of the electro-optic device 100 according to Embodiment 1 of the invention, and FIG. 4A and FIG. 4B are a plan view of pixels adjacent to each other in the first substrate 10, and a cross-sectional view when the electro-optic device 100 is cut at a position corresponding to the line IVB-IVB of FIG. 4A. In FIG. 4A, areas are represented by the following lines.
Scanning Line 3a: Thick Solid Line
Semiconductor Layer 1a: Thin and Short Dot Line
Data Line 6a and Drain Electrode 6b: Chain Line
First Electrode Layer 5a and Relay Electrode 5b: Thin and Long Broken Line
Second Electrode Layer 7a: Two-dot Chain Line
Pixel Electrode 9a: Thick Short Broken Line

As shown in FIG. 4A, on the first substrate 10, the plurality of pixels 100a are provided with the rectangular pixel electrodes 9a, the data lines 6a and the scanning lines 3a are formed along the area overlapped with a vertical and horizontal inter-pixel area 10f interposed by the pixel electrodes 9a adjacent to each other. More specifically, the scanning lines 3a extend along the area overlapped with the first inter-pixel area 10g extending along the scanning lines 3a in the inter-pixel area 10f, and the data lines 6a extend along the area overlapped with the second inter-pixel area 10h extending along the data lines 6a. The data lines 6a and the scanning lines 3a linearly extend, and the pixel transistors 30 are formed in the areas where the data lines 6a and the scanning lines 3a intersect with each other. On the first substrate 10, the first electrode layer 5a (capacitance electrode layer) described with reference to FIG. 2B is formed to be overlapped with the data lines 6a.

As shown in FIG. 4A and FIG. 4B, the first substrate 10 mainly includes a transparent substrate body 10w such as a quartz substrate and a glass substrate, a pixel electrode 9a formed on the surface (one face 10s side) of the liquid crystal layer 50 side of the substrate body 10w, a pixel transistor 30 for pixel switching, and an alignment film 19. The second substrate 20 mainly includes a transparent substrate body 20w such as a quartz substrate and a glass substrate, a common electrode 21 formed on the surface (one face 20s side opposed to the first substrate 10) of the liquid crystal layer 50 side, and an alignment film 29.

In the first substrate 10, the scanning lines 3a formed of a conductive film such as a conductive polysilicon film, a metal silicide film, a metal film, and a metal film compound are formed on one face 10s side of the substrate body 10w. In the embodiment, the scanning line 3a is formed of a light shield film such as tungsten silicide (WSi), and also serves as a light shield film with respect to the pixel transistor 30. In the embodiment, the scanning line 3a is formed of tungsten silicide with a thickness of about 200 nm. An insulating film such as a silicon oxide film may be provided between the substrate body 10w and the scanning lines 3a.

On one face 10s side of the substrate body 10w, an insulating film 12 such as a silicon oxide film is formed on the upper layer side of the scanning lines 3a, and the pixel transistor 30 provided with the semiconductor layer 1a is formed on the surface of the insulating film 12. In the embodiment, the insulating film 12 has, for example, a 2-layer structure of a silicon oxide film formed by a decompression CVD (Chemical Vapor Deposition) method using tetraethoxysilane (Si(OC₂H₅)₄) and a plasma CVD method using tetraethoxysilane and oxygen gas, and a silicon oxide film (HTO (High Temperature Oxide) film) formed by a high temperature CVD method.

The pixel transistor 30 is provided with the semiconductor layer 1a directed to a long side direction in an extending direction of the scanning line 3a in the intersection area of the scanning line 3a and the data line 6a, and a gate electrode 3c extending in a direction perpendicular to a length direction of the semiconductor layer 1a and overlapped with a center part in a length direction of the semiconductor layer 1a. The pixel transistor 30 has a transparent gate insulating layer 2 between the semiconductor layer 1a and the gate electrode 3c. The semiconductor layer 1a is provided with a channel area 1g opposed through the gate insulating layer 2 with respect to the gate electrode 3c, and is provided with a source area 1b and a drain area 1c on both sides of the channel area 1g. In the embodiment, the pixel transistor 30 has an LDD structure. Accordingly, the source area 1b and the drain area 1c are provided with low-concentration areas 1b1 and 1c1 on both sides of the channel area 1g, respectively, and are provided with high-concentration areas 1b2 and 1c2 in an area adjacent on the opposite side to the channel area 1g with respect to the low-concentration areas 1b1 and 1c1, respectively.

The semiconductor layer 1a is configured by a polycrystalline silicon film or the like. The gate insulating layer 2 has a 2-layer structure of a first gate insulating layer 2a formed of a silicon oxide film obtained by thermally oxidizing the semiconductor layer 1a, and a second gate insulating layer 2b formed of a silicon oxide film or the like formed by a CVD method or the like. The gate electrode 3c is formed of a conductive film such as a polysilicon film, a metal silicide film, a metal film, and a metal film compound, and is electrically connected to the scanning lines 3a through contact holes 12a and 12b passing through the second gate insulating layer 2b and the insulating film 12 on both sides of the semiconductor layer 1a. In the embodiment, the gate electrode 3c has a 2-layer structure of a conductive polysilicon film with a film thickness of about 100 nm and a tungsten silicide film with a film thickness of about 100 nm.

In the embodiment, the scanning line 3a is formed by the light shield film to prevent an erroneous operation from occurring, in which the erroneous operation is caused by optical current in the pixel transistor 30 by inputting the reflected light to the semiconductor layer 1a when the light after passing through the electro-optic device 100 is reflected by the other member. However, the scanning lines are formed on the upper layer of the gate insulating layer 2, and a part thereof may be the gate electrode 3c. In this case, the scanning line 3a shown in FIG. 4A and FIG. 4B is formed only to block the light.

A transparent interlayer insulating film 41 formed of a silicon oxide film is formed on the upper layer side of the gate electrode 3c, and the data line 6a and the drain electrode 6b are formed on the upper layer of the interlayer insulating film 41 by the same conductive film. The interlayer insulating film 41 is formed of a silicon oxide film or the like formed by a plasma CVD method using, for example, silane gas (SH₄) and nitrous oxide (N₂O).

The data line 6a and the drain electrode 6b are formed of a conductive film such as a conductive polysilicon film, a metal silicide film, a metal film, and a metal film compound. In the embodiment, the data line 6a and the drain electrode 6b have a 4-layer structure formed by laminating a titanium (Ti) film with a film thickness of 20 nm, a titanium nitride (TiN) film with a film thickness of 50 nm, an aluminum (Al) film with a film thickness of 350 nm, and a TiN film with a film thickness of 150 nm in this order. The data line 6a is electrically connected to the source area 1b (data line side source drain area) through the contact hole 41a passing through the interlayer insulating film 41 and the second gate insulating layer 2b. The drain electrode 6b is formed to be partially overlapped with the drain area 1c (pixel electrode side source drain area) of the semiconductor 1a in the area overlapped with the first inter-pixel area 10g, and is electrically connected to the drain area 1c through the contact hole 41b passing through the interlayer insulating film 41 and the second gate insulating layer 2b.

A transparent interlayer insulating film 42 formed of a silicon oxide film or the like is formed on the upper layer side of the data line 6a and the drain electrode 6b. The interlayer insulating film 42 is formed of, for example, a silicon oxide film or the like formed by the plasma CVD method or the like using tetraethoxysilane and oxygen gas.

The first electrode layer 5a and the relay electrode 5b are formed on the upper layer side of the interlayer insulating film 42 by the same conductive film. The first electrode layer 5a and the relay electrode 5b are formed of a conductive film such as a conductive poly silicon film, a metal silicide film, a metal film, and a metal film compound. In the embodiment, the first electrode layer 5a and the relay electrode 5b has a 2-layer structure of an Al film with a film thickness of about 200 nm and a TiN film with a film thickness of about 100 nm. The first electrode layer 5a extends along an area overlapped with the second inter-pixel area 10h similarly to the data line 6a. The relay electrode 5b is formed to be partially overlapped with the drain electrode 6b in an area overlapped with the first inter-pixel area 10g, and is electrically connected to the drain electrode 6b through the contact hole 42a passing through the interlayer insulating film 42.

An interlayer insulating film 44 such as a silicon oxide film is formed as an etching stopper layer on the upper layer side of the first electrode layer 5a and the relay electrode 5b, and an opening portion 44b is formed on the interlayer insulating film 44 in the area overlapped with the first electrode layer 5a. In the embodiment, the interlayer insulating film 44 is formed of a silicon oxide film or the like formed by the plasma CVD method or the like using tetraethoxysilane and oxygen gas. Although not shown in FIG. 4A, the opening portion 44b is formed in an L shape provided with a part extending along the area overlapped with the first inter-pixel area 10g in which the intersection area of the data line 6a and the scanning line 3a is a base point, and a part extending along the area overlapped with the second inter-pixel area 10h in which the intersection area of the data line 6a and the scanning line 3a is a base point.

A transparent dielectric layer 40 is formed on the upper layer side of the interlayer insulating film 44, and a second electrode layer 7a is formed on the upper layer side of the dielectric layer 40. The second electrode layer 7a is formed of a conductive film such as a conductive polysilicon film, a metal silicide film, a metal film, and a metal film compound. In the embodiment, the second electrode layer 7a is formed of a TiN film with a film thickness of about 100 nm. As the dielectric layer 40, a silicon compound such as a silicon oxide film and a silicon nitride film may be used, and a dielectric layer with a high-dielectric constant such as an aluminum oxide film, a titanium oxide film, a tantalum oxide film, a niobium oxide film, a hafnium oxide film, a lanthanum oxide film, and a zirconium oxide film may be used. The second electrode layer 7a is formed in an L shape provided with a part extending along the area overlapped with the first inter-pixel area 10g in which the intersection area of the data line 6a and the scanning line 3a is a base point, and a part extending along the area overlapped with the second inter-pixel area 10h in which the intersection area of the data line 6a and the scanning line 3a is a base point. Accordingly, in the second electrode layer 7a, the part extending along the area overlapped with the second inter-pixel area 10h is overlapped with the first electrode layer 5a through the dielectric layer 40 with respect to the opening portion 44b of the interlayer insulating film 44. As described above, in the embodiment, the first electrode layer 5a, the dielectric layer 40, and the second electrode layer 7a constitute an accumulation capacitance 55 in the area overlapped with the first inter-pixel area 10g.

In the second electrode layer 7a, the part extending along the area overlapped with the first inter-pixel area 10g is partially overlapped with the relay electrode 5b, and is electrically connected to the relay electrode 5b through the contact hole 44a passing through the dielectric layer 40 and the interlayer insulating film 44.

A transparent interlayer insulating film 45 is formed on the upper layer side of the second electrode layer 7a, and the pixel electrode 9a formed of a transparent conductive film such as an ITO film with a thickness of about 140 nm is formed on the upper layer side of the interlayer insulating film 45. The pixel electrode 9a is partially overlapped with the second electrode layer 7a in the vicinity of the intersection area of the data line 6a and the scanning line 3a, and is electrically connected to the second electrode layer 7a through the contact hole 45a passing through the interlayer insulating film 45.

An alignment film 19 is formed on the surface of the pixel electrode 9a. The alignment film 19 is formed of a resin film such as a polyimide resin or an oblique vapor deposition film such as a silicon oxide film. In the embodiment, the alignment film 19 is an inorganic film (vertical alignment film) formed of an oblique vapor deposition film such as SiOₓ (x<2), SiO₂, TiO₂, MgO, Al₂O₃, In₂O₃, Sb₂O₃, and Ta₂O₅.

In the second substrate 20, the common electrode 21 formed of a transparent conductive film such as an ITO film is formed on the surface (face on the side opposed to the first substrate 10) of the liquid crystal layer 50 side of the transparent substrate body 20w such as a quartz substrate or a glass substrate, and the alignment film 29 is formed to cover the common electrode 21. Similarly to the alignment film 19, the alignment film 29 is formed of a resin film such as a polyimide resin or an oblique vapor deposition film such as a silicon oxide film. In the embodiment, the alignment film 29 is an inorganic film (vertical alignment film) formed of an oblique vapor deposition film such as SiOₓ (x<2), SiO₂, TiO₂, MgO, Al₂O₃, In₂O₃, Sb₂O₃, and Ta₂O₅. The alignment films 19 and 29 are formed by vertically depositing nematic liquid crystal compounds in which dielectric anisotropy is negative used in the liquid crystal layer 50, and the liquid crystal panel 100p operates as a normally black VA mode.

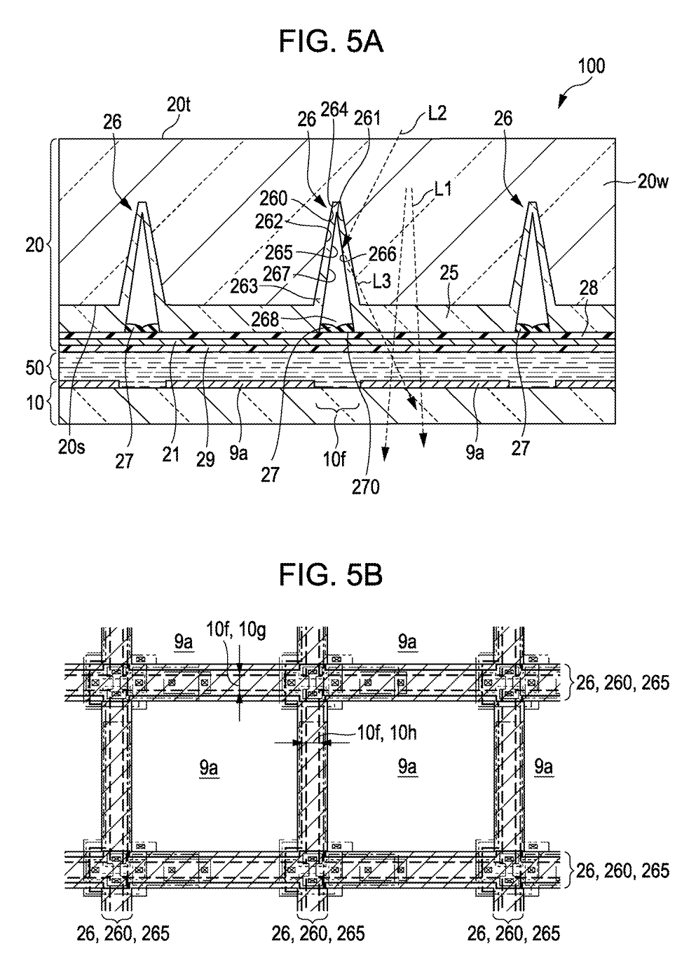

The substrate body 20w of the second substrate 20 is provided with the reflection portion 26 provided with a first groove 260 and a second groove 265 to be described hereinafter with reference to FIG. 5A, FIG. 5B, and the like, and the common electrode 21 or the alignment film 29 is formed on the first substrate 10 side in the reflection portion 26.

### Specific Configuration of Second Substrate 20

FIG. 5A and FIG. 5B are diagrams illustrating the reflection portion 26 formed on the second substrate 20 of the electro-optic device 100 according to Embodiment 1 of the invention, and FIG. 5A and FIG. 5B are a cross-section view illustrating the second substrate 20 and a diagram illustrating a plan configuration of the reflection portion 26. In FIG. 5A, the alignment film 19 and the like on the first substrate 10 side are not shown.

As shown in FIG. 5A and FIG. 5B, in the electro-optic device 100 of the embodiment, the light input from the second substrate 20 side is optically modulated for each pixel by the liquid crystal layer 50, and then is output from the first substrate 10. For this reason, to efficiently use the incident light, it is necessary to efficiently lead the incident light toward the pixel electrode 9a. In the embodiment, the reflection portion 26 reflecting the light which tends to be directed to the space (inter-pixel area 10f) between the pixel electrodes 9a of the light input from the second substrate 20 side, to the pixel electrodes 9a is formed.

In the embodiment, in the reflection portion 26, the first groove 260 is formed in a lattice shape along the area overlapped with the space (the inter-pixel area 10f) between the pixel electrodes 9a in plan view, on one face 20s side of the substrate body 20w (transparent substrate) of the second substrate 20, and the first groove 260 is opened toward the inter-pixel area 10f. In the embodiment, the side faces 261 and 262 of the first groove 260 opposed to each other are inclination faces inclined toward the inter-pixel area 10f. The first groove 260 is formed by etching or the like with respect to the substrate body 20w, and has a substantially isosceles triangular cross section. An apex of the isosceles triangle of the first groove 260 is positioned at the center of the width direction of the inter-pixel area 10f, and the width dimension (the length of the bottom side of the triangle) of the first groove 260 is set larger than that of the inter-pixel area 10f. However, the bottom portion 264 of the face in the first groove 260 is provided, and the cross section of the first groove 260 is a trapezoid close to a triangle.

In the embodiment, the transparent film 25 is formed to be overlapped with one face 20s (substrate face) to which the first groove 260 is opened with respect to the substrate body 20w and the side faces 261 and 262 of the first groove 260. The transparent film 25 is silicate glass (silicon oxide film) using, for example, tetraethoxysilane as raw gas, and a coverage property thereof at the time of forming the film is high. Accordingly, in the transparent film 25, a film thickness of the part overlapped with one face 20s on the outside of the first groove 260 is larger than the film thickness of the part overlapped with the side faces 261 and 262 of the first groove 260. The film thickness of the part overlapped with the side faces 261 and 262 of the first groove 260 of the transparent film 25 gets thinner from the opening portion 263 of the first groove 260 toward the bottom portion 264 of the first groove 260.

For this reason, in the second substrate 20, a second groove 265 deeper than the first groove 260 and narrower than the first groove 260 is formed in the area overlapped with the first groove 260 in plan view. In the embodiment, the depth of the first groove 260 is about 25 μm, and the depth of the second groove 265 is about 33 μm. The side faces 266 and 267 of the second groove 265 opposed to each other are inclination faces inclined toward the inter-pixel area 10f similarly to the side faces 261 and 262 of the first groove 260, and the side faces 266 and 267 of the second groove 265 have a cross-sectional V shape in which the bottom portion and the side faces 266 and 267 are connected to each other. The second groove 265 has a substantially isosceles triangular cross section in which the side faces 266 and 267 are one side, and an apex of the triangle is positioned at the center of the width direction of the inter-pixel area 10f. The width dimension (the length of the bottom side of the triangle) of the second groove 265 is set to be substantially equal to the width dimension of the inter-pixel area 10f or slightly larger than the width dimension thereof.

In the embodiment, the opening portion 268 of the second groove 265 is blocked by a sealing film 27 (sealing layer) formed on the one face 20s side of the substrate body 20w, and the transparent insulating film 28 such as a silicon oxide film is laminated on the opposite side to the side on which the surface 270 side (the opposite face to the side on which the second groove 265 is positioned, and the side on which the first substrate 10 is positioned) of the sealing film 27. In the embodiment, the sealing film 27 is also formed of the transparent insulating film such as a silicon oxide film, similarly to the insulating film 28. However, the sealing film 27 is formed in the condition in which the coverage property thereof is low. For example, the sealing film 27 is formed by the plasma CVD method using silane gas (SH₄), nitrous oxide (N₂O), and the like. For this reason, the sealing film 27 blocks the opening portion 268 to fill up a part of the second groove 265 on the opening portion 268 side of the second groove 265, but is not formed up to the depth of the second groove 265. Accordingly, the second groove 265 is in a hollow state, and the hollow state is kept by the sealing film 27.

The sealing film 27 is formed to partially fill up the second groove 265 on the opening portion 268 side of the second groove 265, but is not formed on one face 20s of the substrate body 20w. The surface 270 of the sealing film 27 constitutes a plane continuous to one face 20s of the substrate body 20w. For this reason, the surface of the insulating film 28 is a flat face, and the common electrode 21 and the alignment film 29 are formed on the flat face.

In the electro-optic device 100 configured as described above, the second groove 265 is in the hollow state. In the embodiment, the inside of the second groove 265 is in a vacuum state. Accordingly, when a refractive index of a medium (vacuum) in the second groove 265 is compared with a refractive index of the transparent film 25 (silicon oxide film), it is in the following relationship. Refractive Index in Second Groove 265<Refractive Index of Transparent Film 25. For this reason, the side faces 266 and 267 of the second groove 265 server as reflection faces. When the refractive index of the transparent film 25 is n₁₁, the refractive index in the second groove 265 is n₁₂, and the incidence angle of the light with respect to the normal line of the side faces 266 and 267 is θ₀, it is n₁₁>n₁₂. Meanwhile, when n₁₁, n₁₂, and θ₀ satisfy the following formula sin θ₀>n₁₂/n₁₁, total reflection occurs on the side faces 266 and 267.

In the embodiment, the refractive index of the silicon oxide film used as the transparent film 25 is substantially the same as the refractive index of the quartz substrate or the glass substrate used in the substrate body 20w. For this reason, the function of the side faces 261 and 262 of the first groove 260 as the reflection faces is very low.

### Operation and Effect of Reflection Portion 26

In the electro-optic device 100 configured as described above, the light at various incidence angles is input from the light source unit 130 described with reference to FIG. 1, the light directed to the pixel electrode 9a of the incidence light propagates as it is as indicated by the arrow L1. As indicated by the arrow L2, the light directed in a direction (direction directed to the inter-pixel area 10f) deviating from the pixel electrode 9a is reflected by the side faces 266 and 267 of the second groove 265 and is directed to the pixel electrode 9a as indicated by the arrow L3.

The second groove 265 has a substantially isosceles triangular cross section in which the side faces 266 and 267 are one side, and an apex of the triangle is positioned at the center of the width direction of the inter-pixel area 10f. The width dimension of the second groove 265 is set to be substantially equal to the width dimension of the inter-pixel area 10f or slightly larger than the width dimension thereof. For this reason, the light directed in the direction drastically deviating from the pixel electrode 9a is reflected toward the pixel electrode 9a, and may be effectively used. Slopes of the side faces 266 and 267 are set, for example, such that the angle formed by the normal line with respect to the substrate face of the substrate body 20w is 10° or less, and 3° or less. According to such a configuration, when the light is reflected by the side faces 266 and 267, it is possible to change the direction of the incident light while reducing an increase of a light beam angle. In addition, it is possible to convert the light into light at a light beam angle capable of sufficiently capturing the incident light by the projective optical system (see FIG. 1) in which an F-number is 2.5. Therefore, it is possible to improve the contrast and to improve the efficiency of using the incident light.

### Method of Producing Second Substrate 20

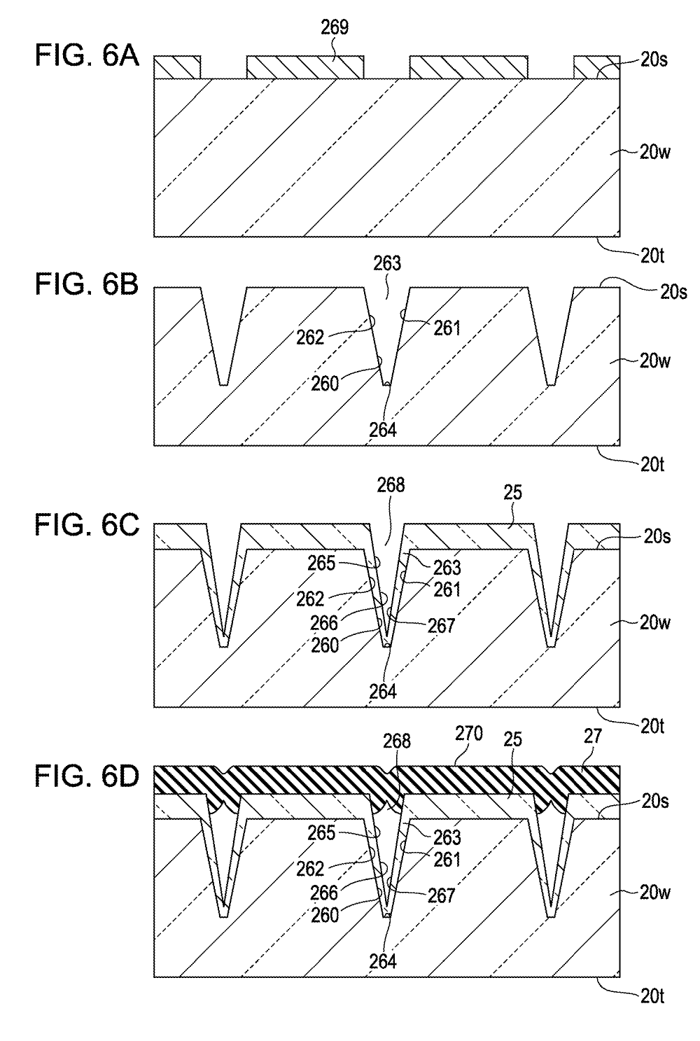

A process of producing the reflection portion 26 in a process of producing the electro-optic device 100 will be described with reference to FIG. 6A to FIG. 6D. FIG. 6A to FIG. 6D are diagrams illustrating the method of producing the electro-optic device 100 according to Embodiment 1 of the invention. FIG. 6A to FIG. 6D show that one face 20s of the second substrate 20 is upward contrary to FIG. 5A and FIG. 5B. As the other process other than the process described hereinafter, for example, a process of producing the first substrate 10 or a process of bonding the first substrate 10 and the second substrate 20, the known method may be employed, and thus it is not described.

To produce the second substrate 20 of the embodiment, in the process of forming the grooves, first, as shown in FIG. 6A, a mask 269 with a thickness of 5 to 10 μm is formed on one face 20s of the substrate body 20w using a photolithography technique. In the embodiment, the mask 269 is a hard mask formed of a metal material of titanium or titanium compound. Then, dry etching is performed on the substrate body 20w. In the dry etching, an etching selection ratio of the substrate body 20w and the mask 269 is for example, 4 or more: 1, using an ICP (ICP-RIE/Inductive Coupled Plasma-RIE) dry etching device capable of forming high-density plasma. AS a result, as shown in FIG. 6B, the first groove 260 in a cross-sectional V shape having a depth four times or more the thickness of the mask 269 is formed. In the embodiment, the depth of the first groove 260 is about 25 μm. In the first groove 260, the side faces 261 and 262 are inclination faces, and a face-shaped bottom portion 264 is formed in the first groove 260. In the process, gas obtained by mixing fluorine-based gas with oxygen or carbon monoxide is used as the etching gas.

Then, in a process of forming the transparent film shown in FIG. 6C, the transparent 25 formed of silicate glass (silicon oxide film) is formed with a thickness of about 10 μm by the decompression CVD method using tetraethoxysilane or the plasma CVD method using tetraethoxysilane and oxygen gas. As a result, on the substrate body 20w, the transparent film 25 is formed to be overlapped with one face 20s (substrate face) to which the first groove 260 is opened and the side faces 261 and 262 of the first groove 260. In a film forming condition when forming the transparent film 25, a coverage property is high. Accordingly, in the transparent film 25, the film thickness of the part overlapped with one face 20s on the outside of the first groove 260 is thicker than the film at the part overlapped with the side faces 261 and 262 of the first groove 260. The film thickness of the part of the transparent film 25 overlapped with the side faces 261 and 262 of the first groove 260 is tapered from the opening portion 263 side of the first groove 260 toward the bottom portion 264 of the first groove 260. For this reason, the second substrate 20 is provided with the second groove 265 deeper than the first groove 260 and narrower than the first groove 260 in the area overlapped with the first groove 260 in plan view, and the depth of the second groove 265 is about 33 μm. The side faces 266 and 267 of the second groove 265 are inclination faces, and have a cross-sectional V shape in which the bottom portion and the side faces 266 and 267 are connected to each other.

Then, in a process of forming the sealing film shown in FIG. 6D, the sealing film 27 blocking the opening portion 268 of the second groove 265 is formed, and the inside of the second groove 265 is in the hollow state. In the embodiment, the sealing film 27 formed of a silicon oxide film is formed by the plasma CVD method using silane gas (SH₄) and nitrous oxide (N₂O). In the film forming condition, the coverage property is low, and the sealing film 27 is formed to protrude from the opening edge of the second groove 265. For this reason, the sealing film 27 is formed to partially fill up the opening portion 268 side of the second groove 265 at the time point of blocking the opening portion 268, but is not formed up to the depth of the second groove 265. For this reason, the second groove 265 is in the hollow state. In the embodiment, the sealing film 27 is formed in the vacuum atmosphere, and thus the inside of the second groove 265 is in the vacuum state.

Then, in the embodiment, the sealing film 27 is polished such that the sealing film 27 remains in the second groove 265 as described with reference to FIG. 5A and FIG. 5B, and the sealing film 27 is removed from the surface of the substrate body 20w on the outside of the second groove 265. In the embodiment, in the polishing process, chemical mechanical polishing is performed. In the chemical mechanical polishing, it is possible to obtain a smooth polished face at a high speed by action of chemical components included in the polishing liquid and relative movement of a polishing agent and the second substrate 20 (substrate body 20w). More specifically, with respect to the polishing device, the polishing is performed while relatively rotating a platen to which a polishing cloth (pad) formed of nonwoven fabric, foamed polyurethane, porous fluorine resin, or the like is attached, and a holder holding the second substrate 20. In this case, for example, the polishing agent including cerium oxide particles with an average diameter of 0.01 to 20 μm, acrylic acid ester derivatives as a dispersing agent, and water is supplied between the polishing cloth and the second substrate 20. As a result, as shown in FIG. 5A and FIG. 5B, the surface 270 of the sealing film 27 constitutes a flat face continuous to one face 20s of the substrate body 20w. Thereafter, the insulating film 28 formed of a silicon oxide film is formed, the common electrode 21 is formed, and the alignment film 29 is formed.

### Main Effect of Embodiment

As described above, in the electro-optic device 100 of the embodiment, the first groove 260 opened to the space (the inter-pixel area 10f) between the pixel electrodes 9a adjacent to each other is formed in the substrate body 20w (transparent substrate) of the second substrate 20 between the first substrate 10 and the second substrate 20. The transparent film 25 is formed on one face 20s of the substrate body 20w and the side faces 261 and 262 of the first groove 260. By the transparent film 25, the second groove 265 deeper than the first groove 260 and narrower than the first groove 260 is formed in the area overlapped with the first groove 260 in plan view. For this reason, it is possible to direct the light which tends to be direction to the inter-pixel area 10f, to the pixel electrodes 9a, using the side faces 266 and 267 of the second groove 265 as the reflection faces. Since the side faces 266 and 267 of the second groove 265 are the inclination faces inclined toward the inter-pixel area 10f, it is possible to reflect the light which tends to be directed to the inter-pixel area 10f by the side faces 266 and 267 of the second groove 265 and to efficiently direct the light to the pixel electrodes 9a.

The transparent film 25 is the silicate glass. That is, the transparent film 25 is the glass (silicon oxide film) using tetraethoxysilane as raw gas. With such a configuration, the coverage property at the time of forming the film is high. For this reason, it is suitable to form the second groove 265 deeper than the first groove 260 and narrower than the first groove 260. In the structure, the reflection faces (the side faces 266 and 267) are large.

The bottom portion of the second groove 265 is narrower than the bottom portion 264 of the first groove 260, and thus the loss of the light caused by inputting the light to the bottom portion of the second groove 265 is small. Particularly, in the embodiment, the side faces 266 and 267 of the second groove 265 are the inclination faces, and has the cross-sectional V shape in which the bottom portion and the side faces 266 and 267 are connected to each other. For this reason, the bottom portion of the second groove 265 is a linear apex portion, and thus most of the loss of the light caused by inputting the light to the bottom portion of the second groove 265 does not occur.

According to the embodiment, it is possible to efficiently direct the light which tends to be directed to the inter-pixel area 10f, to the pixel electrodes 9a, it is possible to raise the light quantity contributing to the displaying, and thus it is possible to display a bright image.

The opening portion 268 of the second groove 265 is blocked by the sealing film 27, and the second groove 265 is hollow. For this reason, the side faces 266 and 267 of the second groove 265 are the reflection faces caused by the difference in refractive index between the medium (vacuum) in the second groove 265 and the transparent film 25, and total reflection occurs on the reflection faces over the broad angle range. Accordingly, it is possible to efficiently direct the light which tends to be directed to the inter-pixel area 10f, to the pixel electrodes 9a. When the opening portion 268 of the second groove 265 is blocked, in the embodiment, the sealing film 27 is used. Accordingly, it is possible to block the opening portion 268 of the second groove 265 only by forming the sealing film 27. Therefore, productivity is high as compared with the case of blocking the opening portion by bonding the cover glass. Since the opening portion 268 of the second groove 265 is blocked by the transparent sealing film 27, the tendency of the light propagating toward the sealing film 27 to be directed to the pixel electrodes 9a is not interfered with.

Since the sealing film 27 is the silicon oxide film formed in the condition of the low coverage property, it is possible to prevent the sealing film 27 from being formed up to the inside of the second groove 265. Therefore, it is possible to increase the areas of the side faces 266 and 267 serving as the reflection faces in the second groove 265. Since the sealing film 27 is formed in the vacuum atmosphere, it is also easy to make the inside of the second groove 265 to be a vacuum.

### MODIFICATION EXAMPLE 1 OF EMBODIMENT 1

In Embodiment 1, when the sealing film 27 is formed, the film forming condition of the low coverage property is employed. Accordingly, in the side faces 266 and 267 of the second groove 265, the contact area of the sealing film 27 and the transparent film 25 is secured narrowly, and the areas of the side faces 266 and 267 (reflection faces) positioned at the hollow part of the second groove 265 is secured broadly. However, when a material with a refractive index lower than that of the transparent film 25 is used as the sealing film 27, it is possible to use the material as the reflection face in a broad range in which the total reflection occurs, also at the contact part of the sealing film 27 and the transparent film 25 on the side faces 266 and 267 of the second groove 265. As the sealing film 27, a magnesium fluoride film (MgF₂/refractive index=1.37) may be used. When the sealing film 27 is the magnesium fluoride film, the refractive index is low as compared with the transparent film 25 (silicon oxide film/refractive index=1.45). As the sealing film 27, a borosilicate glass film, a phosphorus silicate glass film, and a boric phosphorus silicate glass film may be used. The refractive index of the sealing film 27 may be set to a low value by adjusting the content of boron or phosphorous.

### MODIFICATION EXAMPLE 2 OF EMBODIMENT 1

In Embodiment 1, the silicon oxide film is used as the sealing film 27, but a light shield metal material such as metal and metal compound may be used.

### Embodiment 2

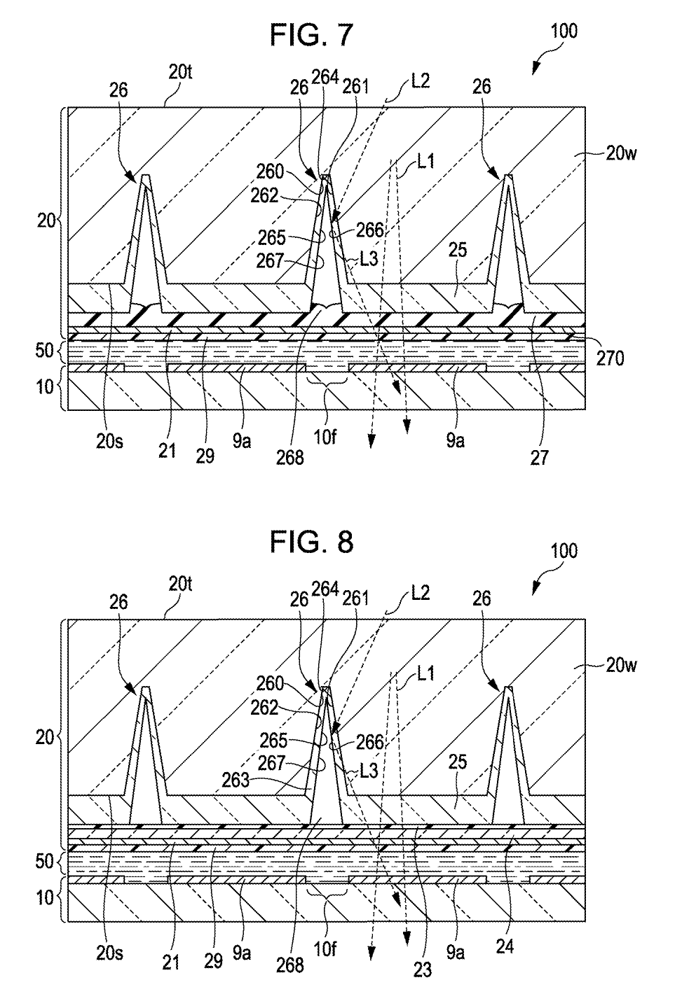

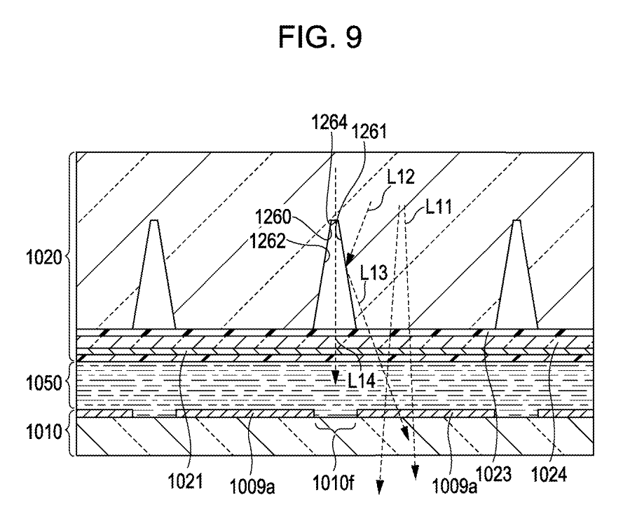

FIG. 7 is a diagram illustrating reflection portions 26 formed on the second substrate 20 of the electro-optic device 100 according to Embodiment 2 of the invention. A basic configuration of the embodiment is the same as that of the Embodiment 1, the same reference numerals and signs are given to the common parts, and the description thereof is not repeated.

In Embodiment 1, the sealing film 27 formed of the silicon oxide film is formed to partially fill up the second groove 265 on the opening portion 268 side of the second groove 265, but is not formed on one face 20s of the substrate body 20w. On the contrary, in the embodiment, as shown in FIG. 7, the sealing film 27 formed of the silicon oxide film is formed to partially fill up the second groove 265 on the opening 268 side of the second groove 265, and is also formed on one face 20s of the substrate body 20w on the outside of the second groove 265. The surface 270 of the sealing film 27 is a continuous flat face, and the common electrode 21 and the alignment film 29 are formed on the surface 270. For this reason, the insulating film 28 shown in FIG. 5A and FIG. 5B may not be formed. As shown in FIG. 6D, the configuration may be realized by setting the polishing amount after forming the sealing film 27 to be smaller than that of Embodiment 1.

### Embodiment 3

FIG. 8 is a diagram illustrating reflection portions 26 formed on the second substrate 20 of the electro-optic device 100 according to Embodiment 3 of the invention. A basic configuration of the embodiment is the same as that of the Embodiment 1, the same reference numerals and signs are given to the common parts, and the description thereof is not repeated.

In Embodiment 1, when the inside of the second groove 265 is hollow, the opening portion 268 of the second groove 265 is blocked by the sealing film 27. In the embodiment, as shown in FIG. 8, a transparent substrate 24 (cover glass/sealing layer) is bonded to one face 20s of the substrate body 20w by the transparent adhesive 23, and the inside of the second groove 265 is in the hollow state by the transparent substrate 24. When the bonding process is performed in the vacuum atmosphere, it is possible to make the inside of the second groove 265 into a vacuum. When the bonding process is performed in the air, it is possible to make the inside of the second groove 265 to be an air layer.

### Other Embodiments

In Embodiments 1 to 3, when the refractive index in the second groove 265 is made lower than the refractive index of the transparent film 25, the opening portion 268 of the second groove 265 is blocked by the sealing layer (the sealing film 27 and the transparent substrate 24), and the inside of the second groove 265 is in the hollow state. However, the inside of the second groove 265 may be filled with a low refractive index material lower than the refractive index of the transparent film 25, and the low refractive index material may be the sealing layer. The low refractive index material may be an inorganic material such as magnesium fluoride or an organic material such as fluorine-based resin.

In Embodiments 1 to 3, the light is input from the second substrate 20 side, and thus the reflection portion 26 is formed on the substrate body 20w of the second substrate 20. However, when the light is input from the first substrate 10 side, the invention may be applied to a case of forming the reflection portion 26 on the substrate body 10w of the first substrate 10.

In Embodiments 1 to 3, the first substrate 10 and the pixel electrode 9a have transparency. However, the invention may be applied to a reflection type electro-optic device 100 in which the pixel electrode 9a is formed of a reflective metal film.

In FIG. 1, the projection type display apparatus 110 using three light values is exemplified. However, the invention may be applied to a case where the electro-optic device 100 is provided therein with a color filter or to an electro-optic device 100 used in a projection type display apparatus in which light with colors is sequentially input to one electro-optic device 100.

In the embodiment, as the electro-optic device, the transmission type electro-optic device 100 used in the projection type display apparatus is exemplified. However, the invention may be applied to a direct view type electro-optic device 100 which displays an image using light output from a backlight device as incident light.

In the embodiment, the liquid crystal device is exemplified as the electro-optic device 100. However, the invention may be applied to a case of forming a reflection portion 26 to increase display light quantity in an electrophoretic type display device. The invention may be applied to a case of forming a reflection portion 26 to suppress a mixed color or the like in an electro-optic device which displays an image on an image display face by modulation light output from a self-light emitting element, such as an organic electroluminescence device.

The entire disclosure of Japanese Patent Application No. 2011-160717, filed Jul. 22, 2011 is expressly incorporated by reference herein.

What is claimed is:

1. An electro-optic device comprising:
a first substrate that is provided with a plurality of pixel electrodes and a plurality of switching elements;
a second substrate that is opposed to the first substrate; and
an electro-optic material layer that is provided between the first substrate and the second substrate,
wherein one of the first substrate and the second substrate is a transparent substrate, and includes a first groove opened to a space between one of the plurality of pixel electrodes and another of the plurality of pixel electrodes that is adjacent to the one of the plurality of pixel electrodes, a transparent film that is laminated on the substrate surface such that a film thickness of the transparent film overlapped with the substrate face to which the first groove is opened is thicker than a thickness of transparent film of a part overlapped with the side faces of the first groove, and has the second groove being deeper than the first groove in an area overlapped with the first groove in plan view and having a width narrower than that of the first groove, and a sealing layer that blocks the second groove such that a refractive index in the second groove is smaller than a refractive index of the transparent film, side faces of the second groove are side faces of the transparent film.

2. The electro-optic device according to claim 1, wherein the side faces of the first groove and the side faces of the second groove are inclination faces inclined toward the space between the one of the plurality of pixel electrodes and the another of the plurality of pixel electrodes that is adjacent to the one of the plurality of pixel electrodes.

3. The electro-optic device according to claim 2, wherein a film thickness of a part of the transparent film overlapped with the side faces of the first groove is tapered from the opening portion side of the first groove toward a bottom portion of the first groove, the film thickness is thinner at the bottom portion.

4. The electro-optic device according to claim 2, wherein the side faces of the second groove have a cross-sectional V shape in which the side faces are connected at a bottom portion thereof.

5. The electro-optic device according to claim 1, wherein the transparent film is silicate glass.

6. The electro-optic device according to claim 1, wherein the second groove is hollow therein.

7. The electro-optic device according to claim 6, wherein the second groove is in a vacuum state therein.

8. The electro-optic device according to claim 1, wherein the first groove and the second groove are provided in the second substrate.

9. The electro-optic device according to claim 8, wherein the plurality of pixel electrodes and the first substrate have transparency.

10. A projection type display apparatus using the electro-optic device according to claim 1, comprising:
a light source unit that outputs light input from one substrate to the electro-optic device; and
a projective optical system that projects light modulated by the electro-optic device.

11. A projection type display apparatus using the electro-optic device according to claim 2, comprising:
a light source unit that outputs light input from one substrate to the electro-optic device; and
a projective optical system that projects light modulated by the electro-optic device.

12. A projection type display apparatus using the electro-optic device according to claim 3, comprising:
a light source unit that outputs light input from one substrate to the electro-optic device; and
a projective optical system that projects light modulated by the electro-optic device.

13. A projection type display apparatus using the electro-optic device according to claim 4, comprising:
a light source unit that outputs light input from one substrate to the electro-optic device; and
a projective optical system that projects light modulated by the electro-optic device.

14. A projection type display apparatus using the electro-optic device according to claim 5, comprising:
a light source unit that outputs light input from one substrate to the electro-optic device; and
a projective optical system that projects light modulated by the electro-optic device.

15. A projection type display apparatus using the electro-optic device according to claim 6, comprising:
a light source unit that outputs light input from one substrate to the electro-optic device; and
a projective optical system that projects light modulated by the electro-optic device.

16. A projection type display apparatus using the electro-optic device according to claim 7, comprising:
a light source unit that outputs light input from one substrate to the electro-optic device; and
a projective optical system that projects light modulated by the electro-optic device.

17. A projection type display apparatus using the electro-optic device according to claim 8, comprising:
a light source unit that outputs light input from one substrate to the electro-optic device; and
a projective optical system that projects light modulated by the electro-optic device.

18. A projection type display apparatus using the electro-optic device according to claim 9, comprising:
a light source unit that outputs light input from one substrate to the electro-optic device; and
a projective optical system that projects light modulated by the electro-optic device.

19. An electro-optic device comprising:
a first substrate, a plurality of pixel electrodes and a plurality of switching elements being provided with the first substrate;
a second substrate that is disposed opposing to the first substrate; and
an electro-optical material that is disposed between the first substrate and the second substrate,
one of the first substrate and the second substrate being transparent,
a groove portion being on the one of the first substrate and the second substrate, the groove portion having a first part and a second part, the groove portion overlapping one of the plurality of pixel electrodes and another of the plurality of pixel electrodes when viewing from a direction from the first substrate toward the second substrate, the first part being a transparent film that is provided between the second part and the one of the first substrate and the second substrate,
the transparent film being on an outside of the groove portion, a thickness of the transparent film on the outside of the groove portion being thicker than a thickness of the transparent film of the first part,
a sealing layer that covers the second portion,
a refractive index of the second part being smaller than a refractive index of the first part.
